(19) United States
(12) Patent Application Publication
(10) Pub. No.: US 2014/0054523 A1
(43) Pub. Date: Feb. 27, 2014

(54) KnuckleSaver Binder Release

(71) Applicant: Keith Roy Williams, Richland, WA (US)

(72) Inventor: Keith Roy Williams, Richland, WA (US)

(21) Appl. No.: 13/595,800

(22) Filed: Aug. 27, 2012

(51) Int. Cl. B66F 19/00

(52) U.S. Cl. CPC B66F 19/00
USPC 254/133 R

(57) ABSTRACT

The KnuckleSaver Binder Release is a safety tool that releases lever-type chain binders with reduced impact danger to the operator. Essentially a J-hook with handles, the operator engages the hook to the handle of the lever-binder and pulls which releases the tension on the binder without dangerous “hands-on” contact with the binder.

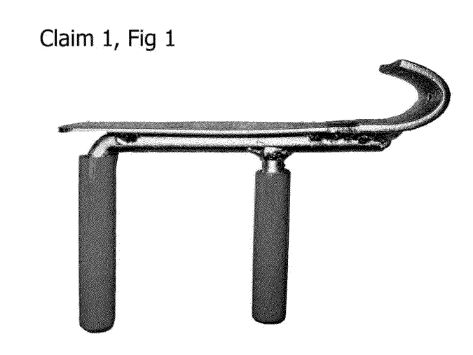

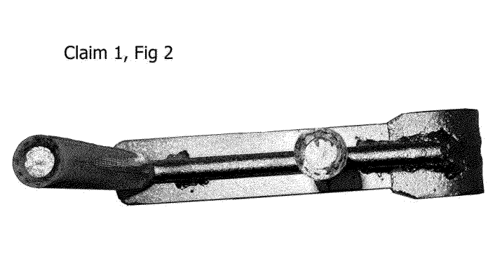

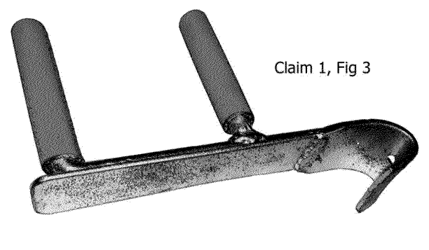

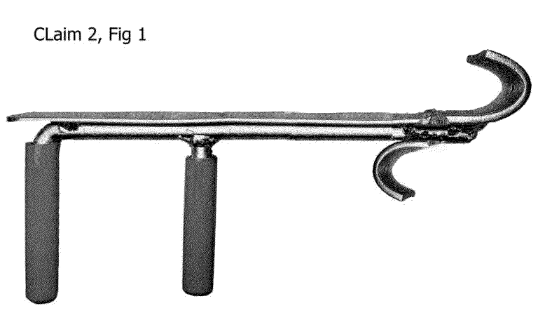

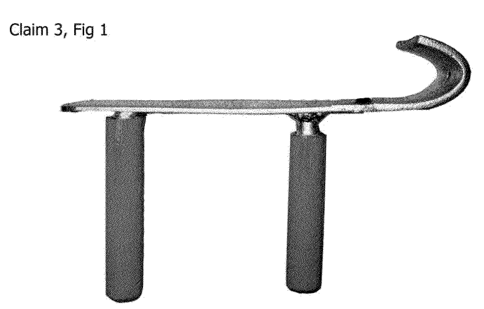

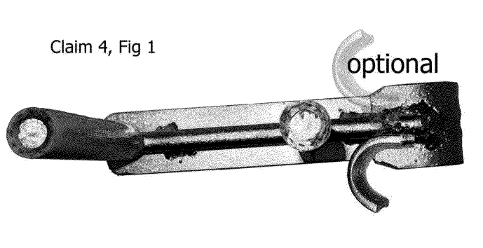

### CROSS-REFERENCE TO RELATED APPLICATIONS

N/A—However as an integral part of this Utility Patent, related:
1) Patent protection for the design and concept description of—“The KnuckleSaver Binder Release”
2) Patent protection and trademark for term—“The KnuckleSaver Binder Release,” and severally for the term “KnuckleSaver.”

### FEDERALLY-SPONSORED RESEARCH

N/A

### SEQUENCE LISTING OR PROGRAM

N/A

### BACKGROUND

### Field of Invention

Anyone who hauls heavy loads on any kind of flatbed truck, trailer or lowboy must secure those loads using either straps or chains. If they use chains then they must use some version of a ratchet binder or one of several varieties of lever-style load binders. The lever-style binders are the simplest to use, least expensive and when used properly, seldom need adjustment after initial application. Thus, the lever-style binder is the most prevalent. However, the lever-style binder can be dangerous to release, especially if the secured load has shifted over the road. When under tension, the lever or handle of the lever binder will rebound with tremendous force, and can snap against the operator's hand, arm or other part of the body causing minor to severe injury. The incautious operator can break knuckles, forearms, snap a kneecap, or lose teeth to the rebounding handle. A safety release tool is needed.

The inventor, working flatbed truck driver, Keith R. Williams, has experienced injuries from rebounding chain binder levers. The KnuckleSaver concept was an idea sparked by a minor hand injury suffered by the truck driver in 2011, and a prototype safety tool was developed in Dan Graf's farm shop in August 2012.

This invention is a heavy metal (plastic, composite, or other materials) J-shaped hook with two handles on the reverse side of the J-hook. A wide metal (plastic, composite, or other materials) bar provides a shield that isolates the operator's hands from the rebounding binder handle or lever. The tool, optionally, can vary in overall length, but the prototype is 8.5 inches long. This tool facilitates the safe release of the standard lever-style chain binder as used by truckers, farmers, crane operators, construction contractors and others. It is a safety item which can prevent hand and arm injuries resultant from the kick-back of the lever that releases the binder when under high tension. The KnuckleSaver is essentially a hook with handles. The operator engages the hook under the binder lever and pulls upward to release the binder. Optionally, there can be a reverse hook on the back side of the tool that can be used to push a stubborn handle upward if it is located high on the load. The design of the tool includes a hand shield that isolates the operator's hands away from the severe and dangerous spring action rebound of the release binder lever. This lowers the risk of broken knuckles, hands and/or forearms on the operator as caused by the impact of rebounding binder levers.

### BACKGROUND

### Prior Art

The inventor is unaware of any directly or indirectly competing patents or directly-related patents to The KnuckleSaver. Ratcheting load binders are available and do not provide the risk of a rebounding handle. However, they can come loose over the road, and so the user risks possible loss of a load. There is a “safety binder” that is an adaptation to the standard lever load binder and has ameliorated the danger of the lever rebound. However, the safety binder is expensive to purchase and more awkward to use so many of those who use chain binders have not moved to that tool. Thus these users continue to absorb the risks of bodily injury caused by lever rebound. Binder bars have been designed to provide a relatively safe binder lever release. However, there are many instances where these four foot long bars will not fit the application. There may not be enough length for the bar to operate, or the binder may be twisted under tension which holds the binder lever tightly against the load, preventing the bar's use. The KnuckleSaver Binder Release solves these problems.

### REFERENCE NUMERALS

N/A

### DETAILED DESCRIPTION

This invention is a heavy metal (plastic, composite, or other materials) J-shaped hook with handles (one handle—or two, as in the prototype) on the reverse side of the J-hook. A wide metal (plastic, composite, or other materials) bar (1.5-3 inches or more in width) provides a shield that isolates the operator's hands from the rebounding binder handle or lever. The tool, optionally, can range in size. The inventors believe from six to eighteen inches in overall length will be most effective. This tool facilitates the safe release of the standard lever-style chain binder as used by truckers, farmers, crane operators, construction contractors and others. It is a safety item which can help prevent hand and arm injuries (and in some instances facial injuries) resultant from the kick-back of the binder handle when released under high tension.

The KnuckleSaver is essentially a hook with handles. The operator engages the hook under the binder lever and pulls upward to release the binder. Optionally, on a longer version of the same tool, there can be a reverse hook on the back side of the tool that can be used to push a stubborn handle upward if it is located high on the load. The design of the tool includes a hand shield that isolates the operator's hands away from the severe spring action rebound of the release binder lever. This lowers the risk of broken knuckles, hands and/or forearms on the operator as caused by the impact of rounding binder levers.

1. The KnuckleSaver Binder Release tool is a metal (plastic, composite, or other materials) J-style hook of appropriate length with handles affixed perpendicular to—and reverse From—the J hook, up the tool from the back of the hook. The handle(s) may be complete with plastic/rubber handgrips. There is a hand shield of wide metal (plastic, composite, or other materials) bar stock or sheet metal (plastic, composite, or other materials) that runs flat up the length of the tool to isolate the users hand from the released binder handle when it springs upward. The operator grips the handle(s), slides the J-hook under the binder handle and pulls up on the lever (binder handle). Once the lever is forced past the release point, kinetic tension will whip the handle upwards under pressure and it will slide harmlessly past the operator's hands along the shield—and the binder is safely released.

2. Device as recited in claim 1, wherein there is a reverse hook on the obverse side and approximately two inches up the frame of the tool from the primary J-hook. This reverse hook is used to push up binder handles to release them when the operator is below the engaged binder implement. This can be useful when the load binder is connected high up on the load.

3. Device as recited in claims 1 and 2, wherein the frame of the tool is simplified and the entire tool is simply made of heavier-gauge bent metal (plastic, composite, or other materials) flat bar stock with one or two handles affixed on the reverse side of the tool from the curve of the J-Hook.

4. Device as recited in claim 1, wherein the optional push-hook is mounted on the side of the frame (pointed 90 degrees to the opening of the J-hook, left or right hand options available, or both sides together) to avoid the potential that the handles may be an obstacle to efficient use.

5. Device as recited in claims 1 through 4, wherein there may be various lengths, widths, handles and hook configurations.
While the invention has been specifically described in connection with certain specific embodiments thereof, it is to be understood that this is by way of illustration and not of limitation, and the scope of the claims should be broadly construed.
